(19) United States
(12) Patent Application Publication
(10) Pub. No.: US 2017/0193181 A1
(43) Pub. Date: Jul. 6, 2017

(54) REMOTE PATIENT MONITORING SYSTEM

(71) Applicant: CERNER INNOVATION, INC., KANSAS CITY, KS (US)

(72) Inventors: BRIAN ROBERT CARTER, LEAWOOD, KS (US); FRANCIS G. RYDZEWSKI, KANSAS CITY, MO (US); RICK STEURER, KANSAS CITY, MO (US); BRYAN TAMKE, KANSAS CITY, MO (US); DAMON MATTHEW HERBST, SHAWNEE, KS (US)

(21) Appl. No.: 15/393,650

(22) Filed: Dec. 29, 2016

Related U.S. Application Data
(60) Provisional application No. 62/273,646, filed on Dec. 31, 2015.

(51) Int. Cl. G06F 19/00

(52) U.S. Cl. CPC G06F 19/3418; G06F 19/322

(57) ABSTRACT

Methods, computer systems, and computer storage media are provided for automatic management of remote patient monitoring devices. Various, disparate types of remote patient monitoring devices may be used to capture medically relevant data relating to a patient. Device inputs may be received in disparate and are assigned a common format for processing. Inputs are associated with a particular device and a particular patient. Duplicate or conflicting inputs are filtered out. Irrelevant inputs are likewise filtered out. The remaining inputs are passed along for further analysis or recordation into a patient's electronic medical record.

### CROSS-REFERENCE TO RELATED APPLICATIONS

This application, having attorney docket number CRNI.243211 and entitled “Remote Patient Monitoring System,” claims priority to U.S. Provisional Application No. 62/273,646, filed Dec. 31, 2015, and entitled “Remote Patient Monitoring System,” the entire contents of which are herein incorporated by reference.

### BACKGROUND

Remote patient monitoring devices have allowed patients to independently monitor a variety of health metrics, such as blood glucose and blood pressure. In this way, remote patient monitoring can improve healthcare outcomes for patients by informing patients of their health metric values on a more frequent and convenient basis.

Remote monitoring devices range in functionality. Some devices, such as blood pressure cuffs and blood glucose meters, collect data similar to what would be checked during a physician's office visit. Recently, wearable devices, such as pedometers and heart rate monitors, have gained popularity.

As a result of the wide range of functionality available, the potential spectrum of care scenarios wherein remote monitoring devices could be used and the type of users is broad. On one end of the spectrum, patients with a serious disease, such as patients recently discharged from hospital, may receive continuous monitoring similar to what they would receive in a recovery ward.

The use of remote monitoring devices can allow for non-critical patients to be discharged from hospital earlier. Medical professionals can maintain near real-time oversight of a patient's condition while the patient is at home. Early detection of changes in patient conditions can allow for early interventions that eliminate the necessity for patient re-admittance to a hospital.

On the other end of the spectrum are active, health-conscious consumers of wearable devices, who might be categorized as part of the Quantified Self movement. Wearables gather information generally related to exercise physiology, which nevertheless provide useful data points in patient medical records. Though this data is often medically relevant, aggregating this data into a patient's electronic medical record (EMR) present various challenges.

Despite the many advantages of remote patient monitoring devices, healthcare providers are currently unable to effectively utilize the available data. While a particular device or device manufacturer might be specialized towards one type of medical reading, many different readings are typically necessary to effectively monitor a patient. In order to get a full and accurate picture of the patient's condition, devices produced by multiple manufactures may be necessary. Data from different devices is generally stored on proprietary cloud platforms provided by the device manufactures. With the increase in availability of various sources of medically relevant data from remote monitoring devices, which is increasingly generated on a continuous basis, an improved means of effective management has become necessary.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The present invention is defined by the claims.

In brief and at a high level, this disclosure describes, among other things, methods, systems and computer readable media for managing remote monitoring devices. Inputs received from various remote monitoring devices are associated with a patient. Irrelevant inputs and duplicate inputs are filtered out, and the remaining inputs are analyzed and incorporated into the patient's electronic medical record (EMR).

Inputs filtered and curated in this way provide data that can be incorporated in various software applications. The data can be analyzed to detect patient health trends. Automated alerts can even be generated in response to significant changes in patient condition. Such software applications could be data source agnostic, eliminating compatibility issues for the applications with new remote monitoring devices inputs.

### BRIEF DESCRIPTION OF THE DRAWINGS

Embodiments are described in detail below with reference to the attached figures, wherein:

FIG. 1 is a system diagram of an exemplary system for remotely monitoring one or more health metrics for a patient suitable to implement embodiments of the present invention;

FIG. 2 depicts a flow diagram illustrating an exemplary method for aggregating and filtering remote monitoring device inputs for use in medical records management and analysis according to one embodiment of the present disclosure;

FIG. 3 depicts a flow diagram illustrating an exemplary method for managing remote monitoring devices according to another embodiment of the present disclosure; and

FIG. 4 is a block diagram of an exemplary computing environment suitable for use in implementing the present disclosure.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combination of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present disclosure are directed to methods, systems, and computer-readable media for managing remote monitoring devices. Inputs received from various remote monitoring devices are associated with a patient. Irrelevant inputs and duplicate inputs are filtered out, and the remaining inputs are analyzed and incorporated into the patient's EMR.

Inputs filtered and curated in this way provide data that can be incorporated in various software applications. The data can be analyzed to detect patient health trends. Automated alerts can even be generated in response to significant changes in patient condition. Such software applications could be data source agnostic, eliminating compatibility issues for the applications with new remote monitoring devices inputs.

In some instances, a single patient may be monitored by multiple devices that generate duplicate inputs. A duplicate input is one of two or more inputs which represent a same clinical parameter. For example, a patient may use a blood pressure cuff which measures both blood pressure and pulse, while simultaneously wearing a watch-type heart rate monitor. In this example, there are only two duplicate inputs relating to the patient's pulse, but in general, a plurality of duplicate inputs may be generated by a plurality of devices. In order to avoid conflicting information from appearing in the patient's EMR, it may be necessary to retain only one of a plurality of duplicate inputs. In some embodiments, the plurality of duplicate inputs may be analyzed in relation to a set of criteria to determine which of the duplicate inputs should be retained. In such embodiments, the set of criteria may include consideration of the clinical veracity of the device that generated the duplicate input. Inputs from the device determined to have a greater relative clinical veracity will be retained over inputs from other devices. In the example above, it may be known that the accuracy of heart rate information generated by the blood pressure cuff is better than the same information generated by the watch-type heart rate monitor.

Accordingly, one aspect of the present disclosure is directed to one or more computer storage media storing computer-useable instructions that, when used by one or more computing devices, cause the one or more computing devices to perform a method of managing remote monitoring devices. The method may comprise receiving a plurality of inputs from a plurality of disparate remote monitoring devices that have been associated with a patient. The plurality of disparate remote monitoring devices comprises at least a first remote monitoring device and a second remote monitoring device.

The method further comprises determining whether a portion of the plurality of inputs is statistically consistent with previously collected inputs for the patient. If the portion of the plurality of inputs is statistically consistent, the portion of the plurality of inputs is aggregated as a set of statistically consistent inputs. If the portion of the plurality of inputs is not statistically consistent, the portion of the plurality of inputs is tagged as a first set of irrelevant inputs.

The method further comprises determining whether the set of statistically consistent inputs comprises duplicate inputs. If there are duplicate inputs, one of the duplicate inputs is determined to be a retained input based on a set of criteria. Then, the selected input is retained and the remaining duplicated inputs are tagged as a second set of irrelevant inputs. The method further comprises communicating the retained input to an EMR associated with the patient.

In another aspect of the present disclosure, a system for managing remote monitoring devices is provided. The system may include a data collection component configured to receive a plurality of inputs from a plurality of remote monitoring devices. The plurality of remote monitoring devices comprises at least a first remote monitoring device and a second remote monitoring device. The system may further include a data store comprising a first set of previously collected inputs relating to the plurality of remote monitoring devices. The system may further include a device/patient association component configured to associate the plurality of inputs with a patient. The system may further include a significance assessment component configured to determine if a portion of the plurality of inputs are statistically consistent inputs. Statistically consistent inputs are statistically consistent with the previously collected inputs. The system may further include a de-conflicting component configured to determine if a portion of the statistically consistent inputs are duplicate inputs. The de-conflicting component may be further configured to communicate a retained input to, for instance, the patient's EMR, wherein the retained input is determined based on a set of criteria.

In yet another aspect of the present disclosure, a computerized method is provided for managing remote monitoring devices. The method comprises receiving a plurality of inputs relating to a patient from a plurality of remote monitoring devices. The plurality of remote monitoring devices comprises at least a first remote monitoring device and a second remote monitoring device. The inputs received from the first remote monitoring device are compared to previously collected inputs. If it is determined that a first portion of the inputs recorded by the first remote monitoring device is statistically inconsistent with the previously collected inputs, the first portion of inputs is tagged as a first set of irrelevant inputs. Next, the plurality of inputs received from the plurality of remote monitoring devices are compared. If it is determined that a second portion of the inputs recorded by both the first remote monitoring device and a third portion of inputs recorded by a second remote monitoring device recorded a same clinical parameter, the second portion of the inputs recorded by the first remote monitoring device and the third portion of the inputs recorded by the second remote monitoring device are evaluated based on a set of criteria. When it is determined that the inputs recorded by the second remote monitoring device are to be retained, based on the set of criteria, the inputs recorded by the first remote monitoring device are tagged as a second set of irrelevant inputs. A retained data set may be created, for use in further processing and analysis, by transforming the inputs received from the plurality of remote monitoring devices into a common format and excluding the irrelevant inputs. The retained data set may be communicated to an EMR associated with the patient.

In order to collect all the relevant inputs, the patient may use multiple remote monitoring devices. Remote monitoring devices may include, but are not limited to, web-enabled scales, blood glucose meters, blood pressure cuffs, heart rate monitors, oximeters, digital peak air flow meters, pedometers, accelerometers and various devices designed to measure galvanic skin response, skin and body temperature, cycling cadence, and the like. In some instances, patients may be prescribed devices, for instance, upon discharge from the hospital or as part of a care management program after being diagnosed with a chronic condition, such as diabetes.

The types of devices used may depend on the patient's condition. For the purpose of illustration, and not limitation, patients may be divided into the categories of active monitoring patients, augmented self-management patients, and Quantified Self patients. Other categories of patients may exist, but these categories are sufficient for illustrative purposes.

Active monitoring describes regular or continuous monitoring of patient vital signs, similar to the type of monitoring the patient might receive while admitted to a hospital. The active monitoring concept is designed for serious disease monitoring. The goal of active monitoring is to prevent the need to readmit patients recovering from a serious disease. Recently discharged patients may be sent home with a prescribed set of remote monitoring devices.

Augmented self-management refers to a strategy for disease management wherein the patient or the patient's core care team, such as family members, are equipped to manage the patient's symptoms most of the time, however the patient's health outcomes could benefit from contact with care providers more frequently than during regularly scheduled office visits. Augmented self-management patients may have a chronic condition, such as diabetes, which is generally well-managed, but may still need additional monitoring from their care team. This may be because the patient is newly diagnosed and is becoming accustomed to a new care plan. These patients may use commercially available devices, such as commercially available blood glucose meters, or prescribed devices, or a combination of both.

The term Quantified Self has emerged to refer to the movement towards incorporating technology into data acquisition on aspects of a person's daily life. The focus within Quantified Self is often on improved performance, whether that be physical or mental, rather than treatment or management of disease. Quantified Self patients are generally consumers of commercially available wearable electronic devices. These devices are primarily geared towards tracking exercise physiology, such a heart rate, steps taken, body temperature and even monitoring blood oxygen levels and posture.

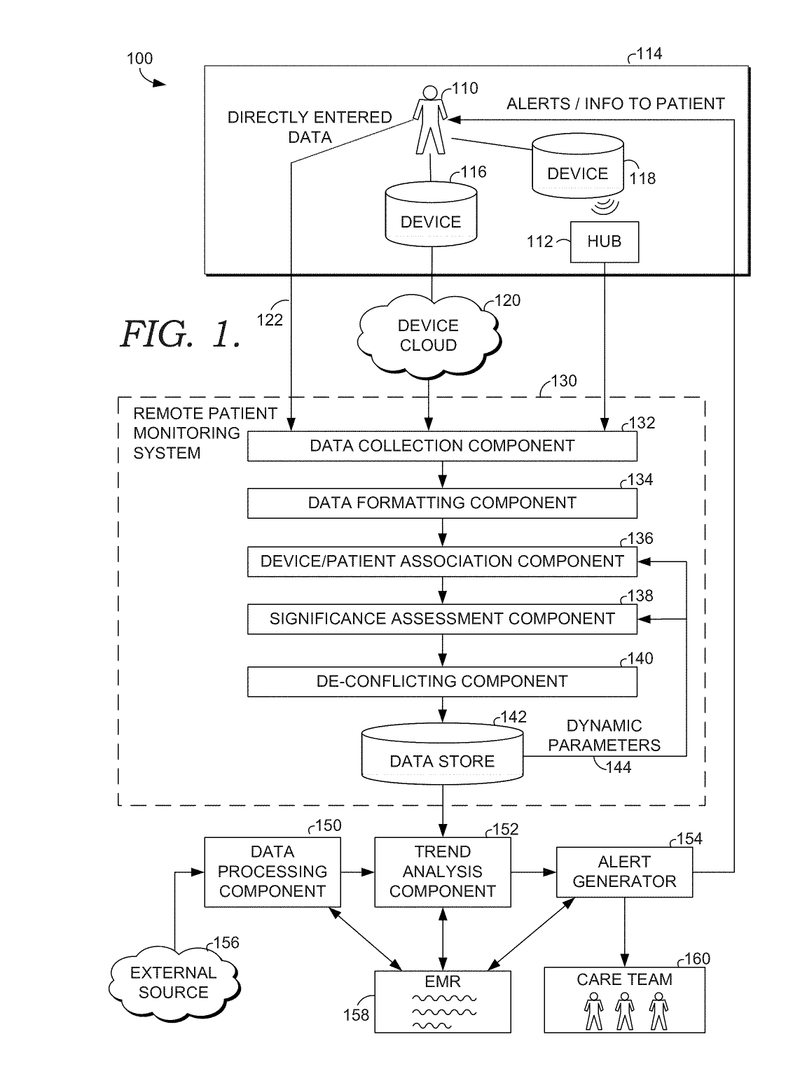

In order to accommodate all of these disparate patient scenarios, embodiments of the present disclosure provide a system for remote device management. In FIG. 1, an exemplary system environment in which embodiments of the disclosure may be implemented is illustrated and designated generally by the reference numeral 100. System 100 allows for remote monitoring of one or more health metrics for a patient 110. Elements of system 100 may be implemented in close proximity to the patient's regular daily location 114. This location may be within an apartment, a single-family home, a nursing home, an ambulatory care facility, or a temporary care facility. There are no constraints on the types of locations where the system 100 may be implemented. In some embodiments, the patient may begin the use of such a system within a hospital or temporary care facility, etc., and then transfer to a second location, such as an apartment or single-family home, etc. For the sake of simplicity, location 114 will be generally referred to as “the patient's home.”

Remote monitoring devices 116 and 118 receive inputs which correspond to a variety of medically relevant data regarding the status of patient 110. Though FIG. 1 depicts two remote monitoring devices 116 and 118, in some embodiments, three or more devices may be used. In other embodiments, only one device may be in use. Remote monitoring devices 116 and 118 may measure data elements including, but not limited to, blood pressure, weight, blood glucose, steps taken, and the like. Remote monitoring devices 116 and 118 may each measure a single data element or they may measure some combination of data elements.

In some embodiments, a short-range radio gateway or hub 112, such as the Qualcomm 2net® Hub, may be installed in the patient's home 114. Wireless signal from the patient's remote monitoring device 118 may be received by the hub 112. Alternatively, device 116 may communicate to device cloud service 120. The device cloud service 120 may be a proprietary cloud service provided by the manufacturer of device 116 or it may be some other cloud-based data system. In some embodiments, multiple devices may communicate to the same cloud service, while in other embodiments there may be one cloud service for each device. In some embodiments, hub 112 may also communicate with a device cloud service similar to device cloud service 120. In addition to inputs collected from remote monitoring devices 116 and 118, directly entered data 122 may be generated by the patient and inputted into the system 100 using, for instance, a patient portal interface. For example, the patient may self-report difficult to quantify information, such as pain, fatigue, vertigo, etc. Such data may be entered in the form of text via a keyboard or a touchscreen, or the data may entered orally via an audio recording or an audio-visual recording device.

Inputs from remote monitoring devices 116 and 118 are received by remote monitoring device management system (DMS) 130. DMS 130 may be comprised of a plurality of components and may include, but is not limited to, a data collection component 132, a data formatting component 134, a device/patient association component 136, a significance assessment component 138, a data store 142, and a de-conflicting component 140. Data collection component 132 may accept incoming data sent from various sources, including but not limited to the various device cloud services 120, hub 112, and directly entered data 122, and makes it available to other components of the DMS 130. Data formatting component 134 may convert the inputs from the various devices (e.g., devices 116 and 118) into a common format in order to normalize the vocabulary within DMS 130. Device/patient association component 136 may receive inputs from data formatting component 134 and recognize and identify which devices are associated with patient 110, and further recognize and identify which inputs are associated with the corresponding devices. In some instances, patient 110 may be prescribed a new device as part of a new or updated care plan, and device/patient association component 136 will update to associate patient 110 with the new device.

In some embodiments, device/patient association component 136 may further depend on dynamic parameters 144 received from data store 142 to aid in associating inputs with a particular device and the device with the particular patient. Dynamic parameters 144 are variables which determine how and when rules encoded in various components are implemented. Dynamic parameters 144 are able to update automatically in response to new data, such as new inputs from remote monitor devices.

Significance assessment component 138 may use dynamic parameters 144, received from data store 142, to determine if the inputs are statistically consistent with previously collected inputs. In some embodiments, dynamic parameters 144 may be generated by comparing new inputs associated with patient 110 with previously collected inputs stored in data store 142. Inputs may be determined to be statistically consistent in various ways. For instance, an input may be determined to be statistically significant if it has a value that differs from prior inputs values by less than some threshold amount, often depending on historic averages. If a new input appears to be a statistical outlier when compared to previously collected inputs for the same device, this may indicate that the new input does not contain medically relevant data. Significance assessment component 138 may tag inputs which appear to be anomalous as irrelevant inputs. For example, a patient may have a device in her home, such as a web-enabled scale, with which she takes daily readings of her weight. Based on historic readings from the device, it's been determined that the patient's weight has averaged 165 lbs. and has varied less than 10 lbs. from that average weight for several months. Should a small child or house pet stand on the scale, the reading would be anomalously low as compared to the patient's historic average. As such, the significance assessment component 138 would tag the reading as an irrelevant input.

In some embodiments, significance assessment component 138 may additionally have preset rules for passing on or publishing data to further components. For instance, a rule may state that only the first blood pressure reading taken each day that is statically consistent is passed along, while any subsequent measurements may be tagged as irrelevant inputs.

De-conflicting component 140 may be included to prevent communication of duplicate inputs. By comparing inputs, de-conflicting component 140 can determine that the same clinical parameter is recorded by more than one device and can retain and communicate only selected inputs. Determination of which input should be retained may be dependent upon any number of criteria. Criteria may include consideration of the relative accuracy or clinical veracity of devices based on device testing. Such tests might be conducted by a standards-setting body, governmental body, regulatory body, and the like. All other duplicate inputs may be tagged as irrelevant inputs. Irrelevant inputs may be discarded, or they may be stored in data store 142 for later diagnostic analysis. For example, the patient's 110 heart rate may be simultaneously monitored by a Holter monitor and by a watch-type heart rate monitor. It may be known that inputs from the Holter monitor are more reliable than similar inputs from a watch-type heart rate monitor, so the inputs from the Holter monitor would be retained and the inputs from the watch-type heart rate monitor would be tagged as irrelevant.

In some embodiments, DMS 130 may publish information to data processing component 150. Data processing component 150 queries the database, applies algorithms, and generates outputs that are consumable by trend analysis component 152 and EMR 158. Data processing component 150 formats inputs into actionable data elements to be communicated to alert generator 154 or visual data elements to be communicated to EMR 158. In some embodiments, in addition to information published from DMS 130, external source data 156 may be received from outside DMS 130. External source data 156 may include, but is not limited to, manually entered data by members of the patient care team 160 or by patient 110, data imported from an external data system, a population health solution, a third-party health solution, data otherwise incorporated into the patient's EMR 158, and the like. For example, a patient may initially be required to take weight measurements once a day, but data may be received from an external source, such as the patient's clinician, to indicate that it would be beneficial for such weight measurements to be taken three times a day instead of once daily. This indication may be received by data processing component 150 and may be passed along to the patient's EMR 158 and to alert generator 154, for instance, to produce a reminder for the patient to weigh herself three times daily instead of once.

Information from DMS 130, as well as external source data 156, may be used to modify the patient's EMR 158 to reflect the retained inputs. In some embodiments, the patient may additionally be able to access and edit their EMR 158 through a patient portal. This information may also be analyzed to uncover trends. In some embodiments, trend analysis component 152 may provide this functionality. Trend analysis component 152 may run data through certain rules and algorithms to analyze and determine how relevant and actionable the data is. Historical data, such as previously collected inputs from remote monitoring devices 116 and 118, may be statistically analyzed to arrive at a baseline of the patient 110, as well as a predictable or predetermined level of variance which is subjectively normal for the patient 110. This baseline, along with the level of variance from the baseline, could allow for the generation of automated intervention or alerts when, for instance, a level of variance for an input exceeds the predictable level of variance. After trend analysis component 152 has performed this analysis and determination, the data may be communicated to further components, such as alert generator 154, or EMR 158. Data may be communicated to EMR 158 as viewable data elements

Alert generator 154 may generate alerts. Alerts may be generated for various reasons, including but not limited to alert generator 154 receiving actionable data elements from trend analysis component 152, inputs passing a predetermined threshold, inputs received after a lapse of time from a previous input, or a combination such factors. Alerts may be generated as automated messages communicated to members of patient care team 160 or to patient 110 directly. Alerts directed to the patient 110 may include requests for new inputs, i.e., a request that the patient weigh herself again. Such a request may be generated after the significance assessment component 138 has flagged a recent input as an irrelevant input. Additionally, alerts may be generated periodically to encourage the patient 110 to continue to engage with her wellness plan.

In another example, an alert may be generated and communicated to a member of the patient's family who has been assigned a role in the patient care team 160. Such an alert may be generated, for example, when the patient 110 fails to generate a requested input, for instance, the patient 110 fails to weigh-in on a web-enabled scale at the scheduled time. The alert, in such a case, would give the patient's family member an opportunity to reach out to patient 110 and determine if additional action need be taken.

As previously stated, alerts may be generated if inputs pass a predetermined threshold. In some embodiments, the predetermined threshold may be based, in whole or in part, on historical data. If the inputs derived from the remote monitoring devices 116 and 118 are outside of a predetermined level of variance based on historical data (such as previously collected inputs for the remote monitoring devices 116 and 118) by a predetermined amount, an alert may be generated to a member of the patient care team 160. The level of variance and the severity associated with it may result in an automated message to emergency personnel for immediate intervention. Additionally, the relative clinical veracity of the device may impact when an alert is generated. For example, an input may be received from a particular device which is within the predetermined level of variance; however, the inclusion of the margin of error for the device results in a measurement outside of the acceptable range and hence the generation of an alert.

Directly entered data 122 may be handled differently from inputs received from remote monitoring devices 116 and 118. In some embodiments, directly entered data 122 will be unaffected by the screening processing of significance assessment component 138 or de-conflicting component 140. Generation of directly entered data 122 may directly result in an alert being generated for a member of the patient care team 160. For example, an alert may be generated which informs a clinician as to the content of directly entered data 122. This provides the clinician the opportunity to take action, for instance, to manually update the patient's EMR 158, or to reach out to the patient 110.

In some embodiments, alerts which otherwise may have been directed to the patient 110 may instead be directed to a member of the patient care team 160. For example, an alert reminding a patient to weigh herself may instead be directed to a member of the care team 160 if it is known that the patient has limited mobility. In some embodiments of the present disclosure, the data processing component 150, trend analysis component 152, and alert generator 154 are separate components. In other embodiments, one or more of these components may be incorporated in the DMS 130.

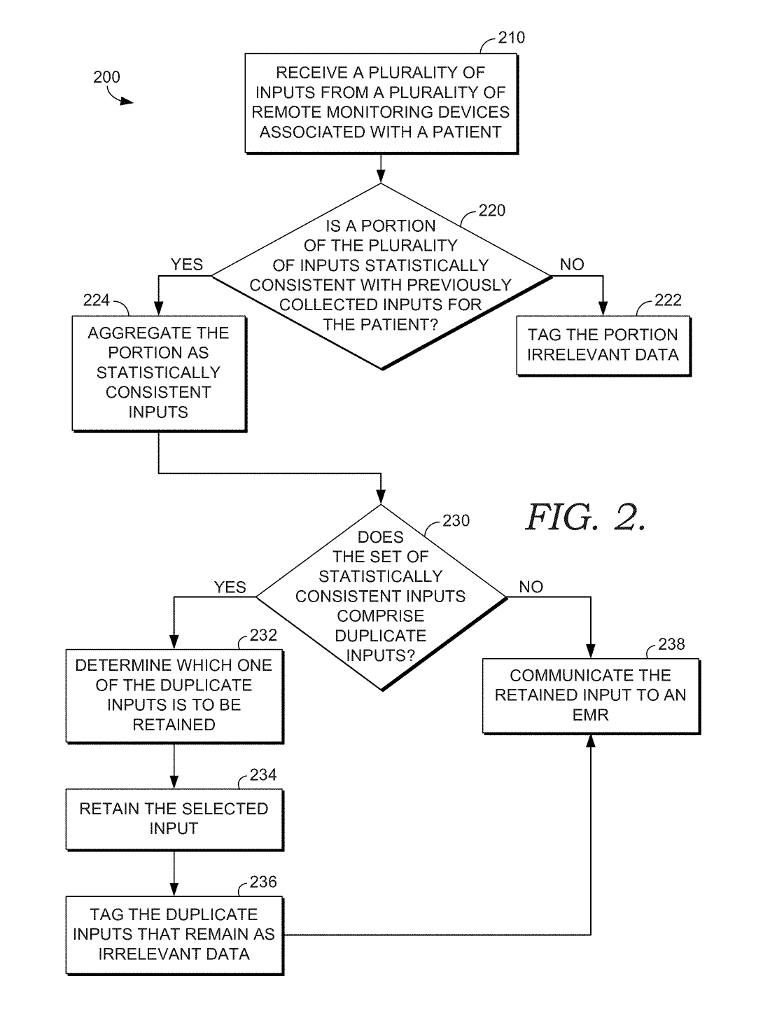

Turning now to FIG. 2, a flow diagram is depicted illustrating a method, labeled generally by the numeral 200, for aggregating and filtering remote monitoring device inputs for use in medical records management and analysis according to one embodiment of the present disclosure. Method 200 may be from the perspective of one or more computing devices functioning as remote monitoring device management system, such as DMS 130 of FIG. 1. Method 200 is applied to discrete portions of the inputs received from remote monitoring devices. These portions may be delineated in various ways, including by time intervals.

At step 210, a plurality of inputs from a plurality of disparate remote monitoring devices that have been associated with a patient are received. The association of the inputs with a patient may have been accomplished by device/patient association component 136. The plurality of disparate remote monitoring devices comprises at least a first remote monitoring device and a second remote monitoring device, such as devices 116 and 118.

At decision point 220, it is determined whether a portion of the plurality of inputs are statistically consistent with previously collected inputs for the patient. Decision point 220 may be executed by significance assessment component 138. The previously collected inputs may be stored in data store 142. In circumstances when the portion of inputs are determined to not be statistically consistent with previously collected inputs, decision point 220 proceeds to step 222. At step 222, the portion of the plurality of inputs is tagged as a first set of irrelevant inputs. Portions of inputs which are tagged as irrelevant inputs are not processed further within method 200.

In circumstances where the portion of inputs are determined to be statistically consistent with previously collected inputs, decision point 220 proceeds to step 224. At step 224, the portion of the plurality of inputs are aggregated as a set of statistically consistent inputs.

With the inputs having passed step 224, method 200 proceeds to decision point 230. At decision point 230, it is determined whether the set of statistically consistent inputs, as aggregated in step 224, comprise any duplicate inputs. Decision point 230 may be executed by de-conflicting component 140. As discussed above, a duplicate input is one of two or more inputs which represent a same clinical parameter. In circumstances when there are duplicate inputs, decision point 230 proceeds to step 232. At step 232, it is determined which of the duplicate inputs is to be a retained based on a set of criteria. As discussed above, the set of criteria may include consideration of the clinical veracity of the device that generated the duplicate input.

At step 234, the selected input is retained. At step 236, the duplicate inputs that remain, i.e. those duplicate inputs which are not retained, are tagged as a second set of irrelevant inputs. In some embodiments, irrelevant inputs may be discarded. In other embodiments, irrelevant inputs may be retained for later diagnostic analysis. Such retained data may be stored in data store 142. In step 238, the retained input is communicated to an EMR associated with the patient.

In circumstances when there are no duplicate inputs, steps 232, 234, and 236 may not be executed, and decision point 230 proceeds directly to step 238. In such circumstances, all statistically consistent inputs are retained and therefore communicated to the patient's EMR.

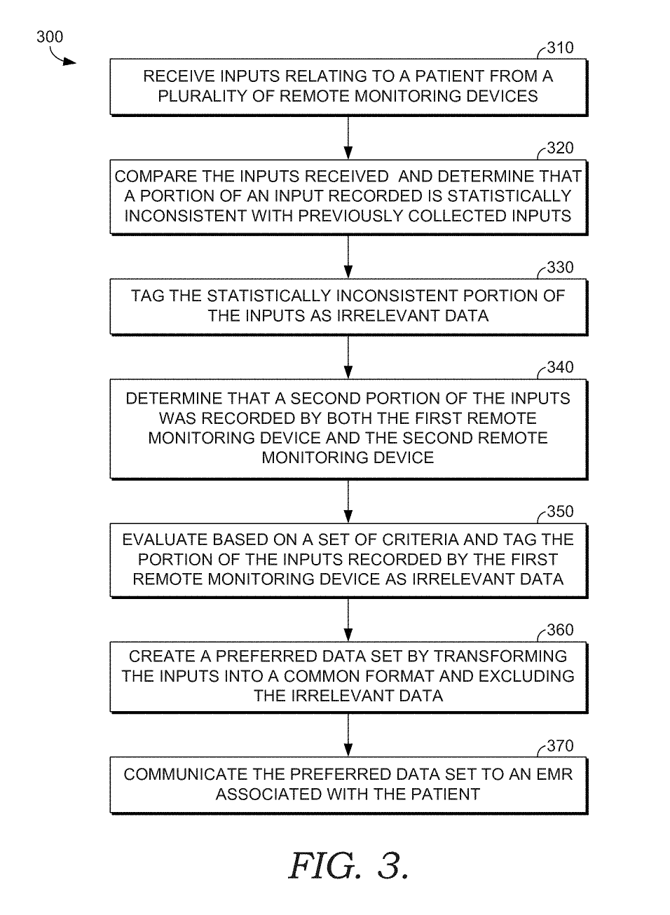

Turning now to FIG. 3, a flow diagram is depicted which illustrates another method, generally referenced by the numeral 300, for managing remote monitoring devices according to another embodiment of the present disclosure. In step 310, a plurality of inputs relating to a patient from a plurality of remote monitoring devices is received. The plurality of remote monitoring devices comprise at least a first remote monitoring device and a second remote monitoring device. At step 320, the plurality of inputs received from the plurality of remoter monitoring devices are compared and a first portion of an input recorded by the first remote monitoring device is determined to be statistically inconsistent with previously collected inputs. At step 330, the first portion of the inputs, being determined to be statistically inconsistent, is tagged as a first set of irrelevant inputs. At step 340, a second portion of the inputs is determined to have been recorded by both the first remote monitoring device and the second remote monitoring device. At step 350, the first portion of the inputs recorded by the first remote monitoring device and the second portion of the inputs recorded by the second remoter monitoring device are evaluated based on a set of criteria and the first portion of the inputs recorded by the first remote monitoring device is tagged as irrelevant inputs. At step 360, a retained data set is created by transforming the inputs received from the plurality of remote monitoring devices into a common format and excluding the irrelevant inputs. The common format refers to a data format that can be processed by applications without regard for the source of the data, thereby allowing application to be data source agnostic, eliminating compatibility issues for the applications with new remote monitoring devices inputs. At step 370, the retained data set is communicated to an EMR associated with the patient.

Having described embodiments of the present invention, an exemplary operating environment in which embodiments of the present invention may be implemented is described below in order to provide a general context for various aspects of the present invention. The exemplary computing system environment, for instance, a medical information computing system, on which embodiments of the present invention may be implemented is illustrated and designated generally as reference numeral 400. It will be understood and appreciated by those of ordinary skill in the art that the illustrated medical information computing system environment 400 is merely an example of one suitable computing environment and is not intended to suggest any limitation as to the scope of use or functionality of the invention. Neither should the medical information computing system environment 400 be interpreted as having any dependency or requirement relating to any single component or combination of components illustrated therein.

The present invention may be operational with numerous other general purpose or special purpose computing system environments or configurations. Examples of well-known computing systems, environments, and/or configurations that may be suitable for use with the present invention include, by way of example only, personal computers, server computers, hand-held or laptop devices, multiprocessor systems, microprocessor-based systems, set top boxes, programmable consumer electronics, network PCs, minicomputers, mainframe computers, distributed computing environments that include any of the above-mentioned systems or devices, and the like.

The present invention may be described in the general context of computer-executable instructions, such as program modules, being executed by a computer. Generally, program modules include, but are not limited to, routines, programs, objects, components, and data structures that perform particular tasks or implement particular abstract data types. The present invention may also be practiced in distributed computing environments where tasks are performed by remote processing devices that are linked through a communications network. In a distributed computing environment, program modules may be located in local and/or remote computer storage media including, by way of example only, memory storage devices.

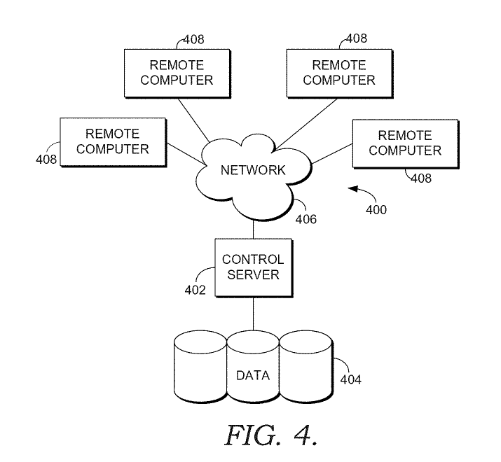

With continued reference to FIG. 4, the exemplary medical information computing system environment 400 includes a general purpose computing device in the form of a server 402. Components of the server 402 may include, without limitation, a processing unit, internal system memory, and a suitable system bus for coupling various system components, including database cluster 404, with the server 402. The system bus may be any of several types of bus structures, including a memory bus or memory controller, a peripheral bus, and a local bus, using any of a variety of bus architectures. By way of example, and not limitation, such architectures include Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

The server 402 typically includes, or has access to, a variety of computer readable media, for instance, database cluster 404. Computer readable media can be any available media that may be accessed by server 402, and includes volatile and nonvolatile media, as well as removable and non-removable media. By way of example, and not limitation, computer readable media may include computer storage media and communication media. Computer storage media may include, without limitation, volatile and nonvolatile media, as well as removable and nonremovable media implemented in any method or technology for storage of information, such as computer readable instructions, data structures, program modules, or other data. In this regard, computer storage media may include, but is not limited to, RAM, ROM, EEPROM, flash memory or other memory technology, CD-ROM, digital versatile disks (DVDs) or other optical disk storage, magnetic cassettes, magnetic tape, magnetic disk storage, or other magnetic storage device, or any other medium which can be used to store the desired information and which may be accessed by the server 402. Computer storage media does not comprise signals per se. Communication media typically embodies computer readable instructions, data structures, program modules, or other data in a modulated data signal, such as a carrier wave or other transport mechanism, and may include any information delivery media. As used herein, the term “modulated data signal” refers to a signal that has one or more of its attributes set or changed in such a manner as to encode information in the signal. By way of example, and not limitation, communication media includes wired media such as a wired network or direct-wired connection, and wireless media such as acoustic, RF, infrared, and other wireless media. Combinations of any of the above also may be included within the scope of computer readable media.

The computer storage media discussed above and illustrated in FIG. 4, including database cluster 404, provide storage of computer readable instructions, data structures, program modules, and other data for the server 402.

The server 402 may operate in a computer network 406 using logical connections to one or more remote computers 408. Remote computers 408 may be located at a variety of locations in a medical or research environment, for example, but not limited to, clinical laboratories, hospitals and other inpatient settings, veterinary environments, ambulatory settings, medical billing and financial offices, hospital administration settings, home health care environments, and clinicians' offices. Clinicians may include, but are not limited to, a treating physician or physicians, specialists such as surgeons, radiologists, cardiologists, and oncologists, emergency medical technicians, physicians' assistants, nurse practitioners, nurses, nurses' aides, pharmacists, dieticians, microbiologists, laboratory experts, genetic counselors, researchers, veterinarians, students, office assistants and the like. The remote computers 408 may also be physically located in non-traditional medical care environments so that the entire health care community may be capable of integration on the network. The remote computers 408 may be personal computers, servers, routers, network PCs, peer devices, other common network nodes, or the like, and may include some or all of the components described above in relation to the server 402. The devices can be personal digital assistants or other like devices.

Exemplary computer networks 406 may include, without limitation, local area networks (LANs) and/or wide area networks (WANs). Such networking environments are commonplace in offices, enterprise-wide computer networks, intranets, and the Internet. When utilized in a WAN networking environment, the server 402 may include a modem or other means for establishing communications over the WAN, such as the Internet. In a networked environment, program modules or portions thereof may be stored in the server 402, in the database cluster 404, or on any of the remote computers 408. For example, and not by way of limitation, various application programs may reside on the memory associated with any one or more of the remote computers 408. It will be appreciated by those of ordinary skill in the art that the network connections shown are exemplary and other means of establishing a communications link between the computers (e.g., server 402 and remote computers 408) may be utilized.

In operation, a user may enter commands and information into the server 402 or convey the commands and information to the server 402 via one or more of the remote computers 408 through input devices, such as a keyboard, a pointing device (commonly referred to as a mouse), a trackball, or a touch pad. Other input devices may include, without limitation, microphones, satellite dishes, scanners, or the like. Commands and information may also be sent directly from a remote healthcare device to the server 402. In addition to a monitor, the server 402 and/or remote computers 408 may include other peripheral output devices, such as speakers and a printer.

Although many other internal components of the server 402 and the remote computers 408 are not shown, those of ordinary skill in the art will appreciate that such components and their interconnection are well known. Accordingly, additional details concerning the internal construction of the server 402 and the remote computers 408 are not further disclosed herein.

The present disclosure has been described in relation to particular embodiments, which are intended in all respects to be illustrative rather than restrictive. Further, the present disclosure is not limited to these embodiments, but variations and modifications may be made without departing from the scope of the present disclosure.

It will be understood that certain features and subcombinations are of utility and may be employed without reference to other features and subcombinations and are contemplated within the scope of the claims. Not all steps listed in the various figures need be carried out in the specific order described.

What is claimed is:

1. One or more computer storage media storing computer-useable instructions that, when used by one or more computing devices, cause the one or more computing devices to perform a method for managing remote monitoring devices, the method comprising:
receiving a plurality of inputs from a plurality of disparate remote monitoring devices that have been associated with a patient, wherein the plurality of disparate remote monitoring devices comprises at least a first remote monitoring device and a second remote monitoring device;
determining whether a portion of the plurality of inputs are statistically consistent with previously collected inputs for the patient, wherein:
when the portion of the plurality of inputs are statistically consistent, aggregating the portion of the plurality of inputs as a set of statistically consistent inputs, and
when the portion of the plurality of inputs are not statistically consistent, tagging the portion of the plurality of inputs as a first set of irrelevant inputs;
determining whether the set of statistically consistent inputs comprises duplicate inputs, wherein:
when there are duplicate inputs, determining that one of the duplicate inputs is a retained input based on a set of criteria,
retaining the retained input, and
tagging the duplicate inputs that remain as a second set of irrelevant inputs; and
modifying an electronic medical record (EMR) associated with the patient to reflect the retained input.

2. The media of claim 1, further comprising:
determining a baseline for the patient based on the previously collected inputs;
determining a predetermined level of variance from the baseline based on the previously collected inputs:
determining that the set of statistically consistent inputs exceeds the predetermined level of variance by a first predetermined amount; and
communicating a first alert to a first member of a patient care team based on the set of statistically consistent inputs exceeding the predetermined level of variance by the first predetermined amount.

3. The media of claim 2, further comprising generating an automated intervention based on the set of statistically consistent inputs exceeding the predetermined level of variance by the first predetermined amount.

4. The media of claim 1, wherein the first and second sets of irrelevant inputs are retained in a data store.

5. The media of claim 1, wherein the set of criteria comprises a relative clinical veracity of a first remote monitoring device as compared to a second remote monitoring device, wherein the first remote monitoring device and the second remote monitoring device measure the same clinical parameter.

6. The media of claim 1, wherein at least one of the plurality of remote monitoring devices is a web-enabled scale.

7. The media of claim 1, wherein at least one of the plurality of remote monitoring devices is configured to track exercise physiology.

8. A system for managing remote monitoring devices comprising:
a data collection component configured to receive a plurality of inputs from a plurality of remote monitoring devices, wherein the plurality of remote monitoring devices comprises at least a first remote monitoring device and a second remote monitoring device;
a data store comprising a first set of previously collected inputs relating to the plurality of remote monitoring devices;
a device/patient association component configured to associate the plurality of inputs with a patient;
a significance assessment component configured to determine if a portion of the plurality of inputs are statistically consistent inputs, wherein statistically consistent inputs are statistically consistent with the first set of previously collected inputs; and
a de-conflicting component configured to determine if a portion of the statistically consistent inputs are duplicate inputs and further configured to modify an electronic medical record (EMR) associated with the patient to reflect a retained input, wherein the retained input is determined based on a set of criteria.

9. The system of claim 8, further comprising a hub configured to communicate the plurality of inputs from the plurality of remote monitoring devices to the data collection component.

10. The system of claim 8, wherein the set of criteria for the de-conflicting component comprises a relative clinical veracity of the first remote monitoring device as compared to the second remote monitoring device, wherein the first remote monitoring device and the second remote monitoring device measure the same clinical parameter.

11. The system of claim 8, further comprising a trend analysis component configured to evaluate the statistically consistent inputs in context of the first set of previously collected inputs.

12. The system of claim 8, further comprising an alert generator configured to generate automated messages to one or more members of a patient care team.

13. The system of claim 8, further comprising a data formatting component configured to convert inputs from one or more of the plurality of remote monitoring devices into a common format.

14. The system of claim 12, wherein the patient care team includes the patient.

15. The system of claim 12, wherein the patient care team includes a member of the patient's family.

16. A computerized method carried out by at least one computing device having at least one processor for managing remote monitoring devices, the method comprising:
receiving a plurality of inputs relating to a patient from a plurality of remote monitoring devices, wherein the plurality of remote monitoring devices comprises at least a first remote monitoring device and a second remote monitoring device;
comparing inputs received from the first remote monitoring device to previously collected inputs;
determining that a first portion of inputs recorded by the first remote monitoring device is statistically inconsistent with the previously collected inputs;
tagging the first portion of the inputs as a first set of irrelevant inputs;
determining that a second portion of the inputs recorded by the first remote monitoring device and a third portion of inputs recorded by the second remote monitoring device recorded a same set clinical parameter;
evaluating the second portion of the inputs recorded by the first remote monitoring device and the third portion of the inputs recorded by the second remote monitoring device based on a set of criteria and tagging the first portion of the inputs recorded by the first remote monitoring device as a second set of irrelevant inputs;
creating a retained data set by transforming the inputs received from the plurality of remote monitoring devices into a common format and excluding the first and second sets of irrelevant inputs; and
modifying an electronic medical record (EMR) associated with the patient to reflect the retained data set.

17. The method of claim 16, where in the set of criteria comprises a relative clinical veracity of the first remote monitoring device as compared to the second remote monitoring device.

18. The method of claim 16, wherein the inputs for at least one of the plurality of remote monitoring devices are received from a cloud service.

19. The method of claim 16, wherein the inputs for at least one of the plurality of remote monitoring devices are received directly from the remote monitoring devices.

20. The method of claim 16, wherein the inputs tagged as irrelevant are stored.
